(19) United States
(12) Patent Application Publication
(10) Pub. No.: US 2026/0300146 A1
(43) Pub. Date: Oct. 1, 2026

(54) INTELLIGENT SYSTEM FOR GENERATING DYNAMIC IMPLEMENTATION PROTOCOLS

(71) Applicant: BANK OF AMERICA CORPORATION, Charlotte, NC (US)

(72) Inventors: Manasa Krishna Gaddam, Hyderabad (IN); Venugopala Rao Randhi, Hyderabad (IN); Satya Murthy Yenamandra, Hyderabad (IN); A Likhitha, Hyderabad (IN)

(73) Assignee: BANK OF AMERICA CORPORATION, Charlotte, NC (US)

(21) Appl. No.: 19/090,875

(22) Filed: Mar. 26, 2025

(51) Int. Cl. G06F 11/3668

(52) U.S. Cl. CPC G06F 11/3692

(57) ABSTRACT

Systems, computer program products, and methods are described herein for automated test analysis and diagnostics in a distributed computing environment. The system includes an edge node configured to execute test cases on a plurality of applications associated with an end-point device, and generate execution data in response. A data processing subsystem is configured to analyze the execution data, detect execution variability in the execution of each test case, and generate execution analysis data in response. A machine learning subsystem is configured to determine a root cause associated with the execution variability based on at least the execution analysis data. The machine learning subsystem further generates responsive actions to modify the test case execution and mitigate the root cause of execution variability. The system may iteratively refine execution parameters by implementing the responsive actions through an action implementation subsystem, which enforces modifications via a smart contract and validates test re-execution.

### TECHNOLOGICAL FIELD

Example embodiments of the present disclosure relate to systems and methods for identifying, diagnosing, and mitigating inconsistent test cases in complex, distributed software applications.

### BACKGROUND

Inconsistent tests undermine the credibility of automated testing frameworks, leading to delays in software development cycles, increased maintenance costs, and reduced confidence in test results. Conventional inconsistent test detection and mitigation techniques rely on re-executing test cases multiple times to determine stability, which is computationally expensive and inefficient. Additionally, most testing frameworks lack real-time intelligence, dependency tracking, security validation, and holistic data transformation analysis, making them inadequate for modern distributed applications. Given these challenges, there is a need for a robust, automated, and intelligent system to improve the accuracy, efficiency, and reliability of automated test execution in distributed systems.

Applicant has identified a number of deficiencies and problems associated with automated testing frameworks. Many of these identified problems have been solved by developing solutions that are included in embodiments of the present disclosure, many examples of which are described in detail herein.

### BRIEF SUMMARY

Systems, methods, and computer program products are provided for automated test analysis and diagnostics in a distributed computing environment.

In one aspect, a system for automated test analysis and diagnostics in a distributed computing environment is presented. The system comprising: an edge node, wherein the edge node is configured to execute test cases on a plurality of applications associated with an end-point device, wherein edge node is further configured to generate execution data in response to executing each test case; a data processing subsystem operatively coupled to the edge node, wherein the data processing subsystem is configured to: analyze the execution data corresponding to each test case; detect execution variability in the execution of each test case in response to analyzing the corresponding execution data; and generate execution analysis data for each test case in response to detecting the execution variability; and a machine learning subsystem operatively coupled to the data processing subsystem, wherein the machine learning subsystem is configured to: determine a root cause associated with the execution variability in the test case based on at least the execution analysis data; and generate responsive actions to modify the test case execution and removing the root cause associated with the execution variability in the test case.

In some embodiments, the edge node is one or a plurality of edge nodes.

In some embodiments, the edge node further comprises a smart self-monitoring agent, wherein the smart self-monitoring agent is configured to: monitor, in real-time, the execution of test cases on the plurality of applications; and generate the execution data based on at least monitoring the execution of test cases, wherein the execution data comprises at least one of Application Performance Monitoring (APM) metrics, security and permission logs, or data transformation logs.

In some embodiments, the data processing subsystem is further configured to: detect, using a swarm analyzer module, the execution variability in the execution of each test case.

In some embodiments, the data processing subsystem is further configured to: generate, using a test case analyzer module, the execution analysis data, wherein the execution analysis data comprises at least one of dependency impact portfolio, data transformation integrity metrics, and security and access validation dataset.

In some embodiments, the dependency impact portfolio comprises at least one of interdependency mappings between the test cases, identifying relationships between upstream and downstream test case executions, execution flow data capturing a sequence and timing of dependent test cases to assess cascading failure effects, impact propagation metrics determining a degree to which failures in one test case influence execution of related test cases, historical execution patterns analyzing prior test results to detect recurring dependency-related inconsistencies, or regression test triggers identifying conditions under which a failure in an upstream test necessitates a re-execution of related downstream test cases.

In some embodiments, the data transformation integrity metrics comprises at least one of data format consistency parameters, precision and rounding variation metrics, serialization and deserialization consistency data, cross-system data validation records, or schema and type compliance indicators.

In some embodiments, the security and access validation dataset comprises at least one of authentication and authorization logs, access control policy compliance records, encryption and data integrity validation parameters, failed authentication and permission denial events, or security exception and anomaly detection indicators.

In some embodiments, the machine learning subsystem is further configured to: implement a neuro-symbolic model on the execution analysis data, wherein implementing the neuro-symbolic model further comprises: generating, using a neural network, probability scores indicating a likelihood of execution variability; and interpreting, using a rule-based inference engine, the probability scores by correlating execution variability patterns with predefined domain-specific rules to generate an execution variability classification dataset.

In some embodiments, the machine learning subsystem is further configured to: determine the root cause associated with the execution variability based on at least the execution variability classification dataset.

In some embodiments, the system further comprises an action implementation subsystem, wherein the action implementation subsystem is configured to: store the responsive actions in a smart contract as test case re-execution parameters; and recording the smart contract in a distributed ledger.

In some embodiments, the action implementation subsystem is further configured to: transmit the test case re-execution parameters to the edge node; determine that the edge node has implemented the re-execution parameters; and automatically re-execute the test case in response to determining that the edge node has implemented the re-execution parameters.

In another aspect, a method for automated test analysis and diagnostics in a distributed computing environment is presented. The method comprising: executing, using an edge node, test cases on a plurality of applications associated with an end-point device, wherein executing further comprises generating execution data in response to executing each test case; analyzing, using a data processing subsystem, the execution data corresponding to each test case; detecting, using a data processing subsystem, execution variability in the execution of each test case in response to analyzing the corresponding execution data; generating execution analysis data for each test case in response to detecting the execution variability; determining, using a machine learning subsystem, a root cause associated with the execution variability in the test case based on at least the execution analysis data; and generating, using the machine learning subsystem, responsive actions to modify the test case execution and removing the root cause associated with the execution variability in the test case.

In yet another aspect, a computer program product for automated test analysis and diagnostics in a distributed computing environment is presented. The computer program product comprising a non-transitory computer-readable medium comprising code configured to cause an apparatus to: execute, using an edge node, test cases on a plurality of applications associated with an end-point device, wherein executing further comprises generating execution data in response to executing each test case; analyze, using a data processing subsystem, the execution data corresponding to each test case; detect, using a data processing subsystem, execution variability in the execution of each test case in response to analyzing the corresponding execution data; generate execution analysis data for each test case in response to detecting the execution variability; determine, using a machine learning subsystem, a root cause associated with the execution variability in the test case based on at least the execution analysis data; and generate, using the machine learning subsystem, responsive actions to modify the test case execution and removing the root cause associated with the execution variability in the test case.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for automated test analysis and diagnostics in a distributed computing environment, in accordance with an embodiment of the disclosure;

FIG. 2 illustrates an example architecture 200 for automated test analysis and diagnostics in a distributed computing environment, in accordance with an embodiment of the disclosure; and

FIG. 3 illustrates a process flow for automated test analysis and diagnostics in a distributed computing environment, in accordance with an embodiment of the disclosure.

### DETAILED DESCRIPTION

### Overview

Modern distributed computing environments face significant challenges in automated software testing, particularly with inconsistent test cases that yield unpredictable results despite no changes in the underlying code or test environment. These inconsistencies undermine the reliability of automated testing frameworks, delay software deployment, and increase debugging complexity. The primary technical issues include intermittent test failures, complex interdependencies between upstream and downstream components, security and permission constraints that cause false test failures, and data transformation inconsistencies that lead to precision loss or format mismatches. Conventional debugging methods rely on extensive manual investigation, requiring developers to analyze logs, execution patterns, and system dependencies, which is time-consuming and inefficient.

Embodiments of the disclosure provide an automated, intelligent approach to identifying, analyzing, and mitigating inconsistent test cases in distributed environments. By leveraging edge computing, swarm intelligence, application performance monitoring (APM), dependency analysis, security validation, data transformation analysis, and neuro-symbolic AI, the embodiments of the disclosure reduce reliance on manual debugging, improve test accuracy, and optimize computing resource utilization. Test execution is distributed across edge nodes, reducing latency and computational load on centralized test environments. Smart self-monitoring agents collect real-time APM metrics, security logs, and data transformation data, while swarm intelligence algorithms dynamically detect and categorize inconsistent test cases based on execution variability. Embodiments of the disclosure further apply neuro-symbolic AI to map inconsistent test cases to specific root causes, translating complex AI-driven analysis into human-readable explanations. Automated decision-making via decentralized autonomous organization (DAO) decision-making and smart contracts streamlines defect validation and triggers test re-execution without manual intervention.

Additionally, embodiments of the disclosure provide several real-world applications and technical advantages. For instance, by optimizing test execution using edge computing, the system reduces network traffic and computational overhead. Instead of re-executing entire test suites, the system isolates specific inconsistent test cases, thereby minimizing redundant processing and conserving storage resources. AI-driven fluctuation analysis allows for greater accuracy by distinguishing between genuine defects and transient test instabilities, preventing unnecessary debugging efforts. Security-aware validation differentiates authentication and access-related failures from actual test errors, further improving result accuracy. Additionally, automated root cause identification reduces developer workload by immediately correlating inconsistent test cases to their underlying system modules. Through decentralized and smart contract execution, defect validation is automated, eliminating manual approval bottlenecks and accelerating software deployment.

The system also optimizes resource allocation by selectively triggering regression tests for impacted downstream components rather than executing unnecessary full-suite tests, reducing network congestion and computing workload. A continuous feedback loop refines AI models over time, improving the accuracy of test failure predictions and minimizing resource-intensive recalculations. Unlike conventional test automation frameworks, embodiments of the disclosure introduce neuro-symbolic AI to provide interpretable and actionable insights, making test analysis more transparent and efficient. This hybrid AI approach, which integrates predictive analytics with symbolic reasoning, enables a deeper understanding of test failures that was previously unachievable through conventional test execution systems.

Furthermore, the system increases test execution efficiency by reducing redundant test runs and manual debugging efforts. Dependency-aware regression testing ensures that only necessary test cases are re-executed, significantly lowering CPU, memory, and bandwidth usage. Security-aware test validation prevents false test failures due to access control issues, while data transformation analysis mitigates inconsistencies caused by precision loss or formatting errors. Smart contract execution ensures that validated test failures are automatically processed and addressed, further reducing manual intervention. By integrating multiple intelligent automation layers, embodiments of the disclosure significantly improve the efficiency, accuracy, and reliability of automated testing in distributed environments, making it a valuable solution for optimizing continuous integration and deployment (CI/CD) workflows.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

### Example System Environment

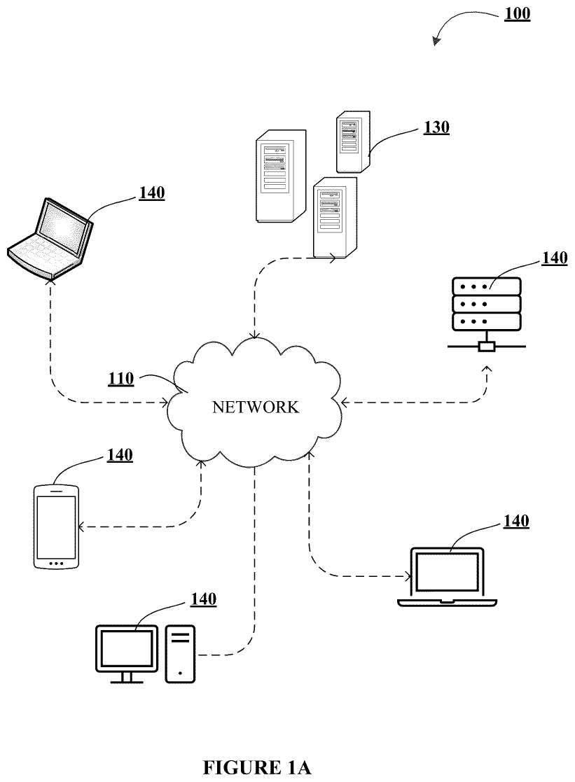

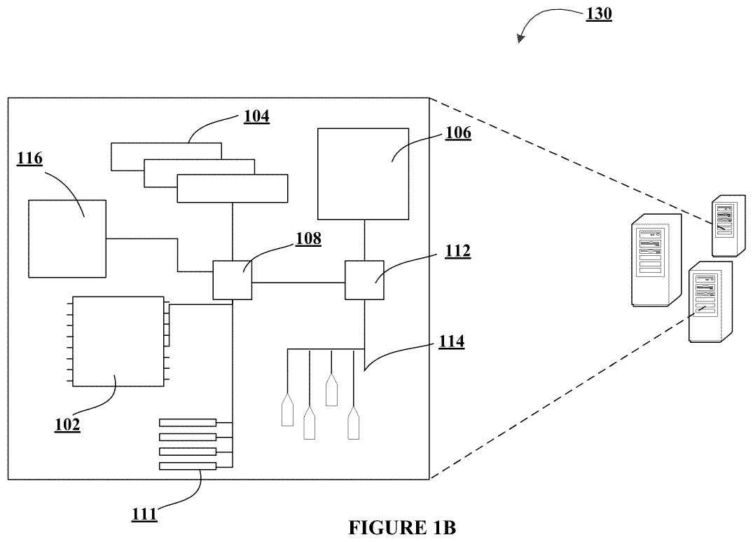

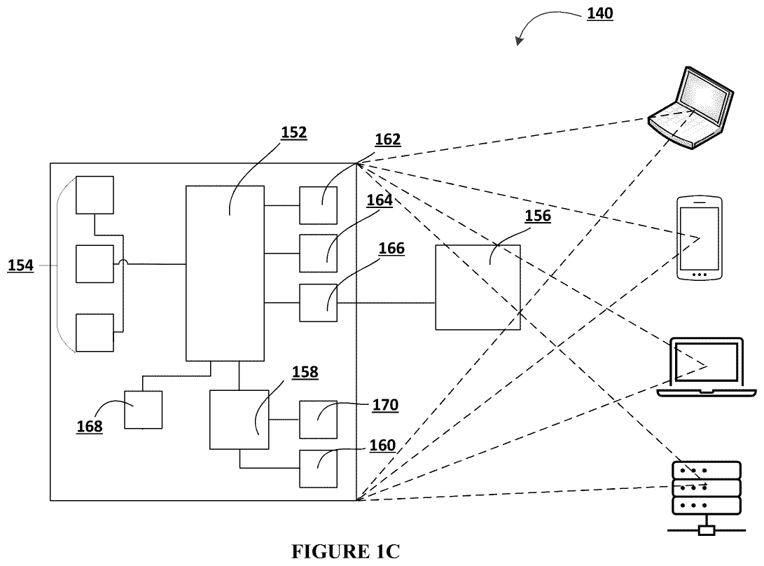

FIGS. 1A-1C illustrate technical components of an exemplary distributed computing environment 100 for automated test analysis and diagnostics, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file servers, or the like, as well as a range of digital computing devices, including laptops, desktops, video recorders, audio/video players, radios, workstations, and/or the like. Additionally, system 130 may include a variety of auxiliary network devices, encompassing wearable devices, Internet-of-things (IoT) devices, electronic kiosk devices, entertainment consoles, mainframes, and/or the like, in any combination to cater to the complexity and diversity of contemporary digital ecosystems.

The end-point device(s) 140 may encompass an array of electronic devices, such as personal digital assistants, cellular telephones, smartphones, laptops, desktops, and merchant input devices like point-of-sale (POS) systems, electronic payment kiosks, and automated teller machines (ATMs). End-point device(s) 140 may also include edge devices like routers, routing switches, integrated access devices (IAD), and/or the like, and devices capable of interfacing with 5G networks, delivering enhanced data processing and connectivity.

The network 110 may include a distributed network architecture that spans a variety of network types, facilitating a cohesive data communication network that can be managed jointly or individually. The network architecture supports shared communication as well as distributed processing across platforms such as telecommunication networks, local area networks (LAN), wide area networks (WAN), global area networks (GAN), the Internet infrastructure, and/or the like. Network 110 may also integrate emerging networking technologies, including software-defined networking (SDN), network function virtualization (NFV), and next-generation wireless communication standards like 5G. Network 110 may employ secure or unsecure, as well as wireless, wired, and optical interconnection technologies, and/or the like, to accommodate a spectrum of communication and processing needs.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

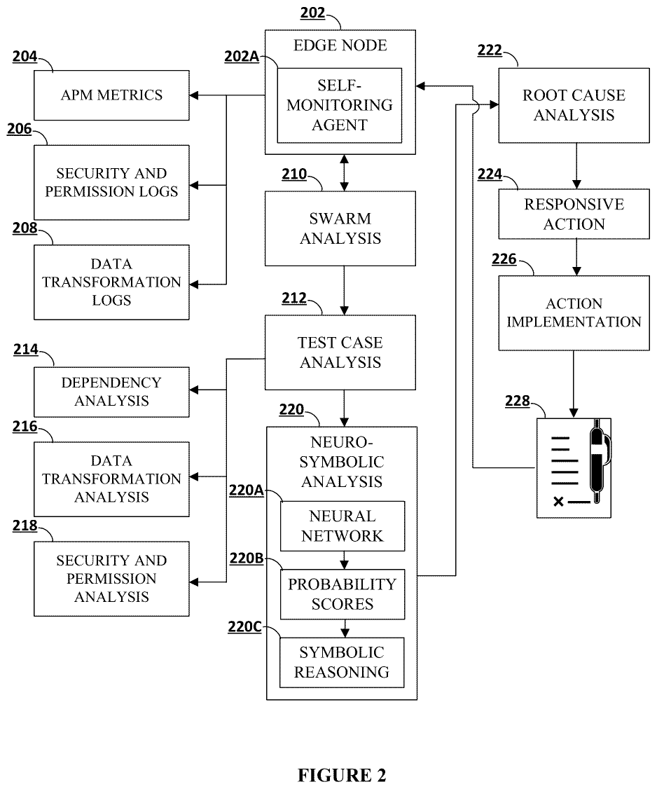

FIG. 2 illustrates an example architecture 200 for automated test analysis and diagnostics in a distributed computing environment, in accordance with an embodiment of the disclosure. As described herein with respect to FIG. 1, the system (e.g., system 140) may include a plurality of subsystems configured to facilitate automated test execution, analysis, and diagnostics within the distributed computing environment (e.g., distributed computing environment 100). The system may access a plurality of edge nodes 202, which may be deployed as independent computing resources within the network or instantiated directly on the end-point devices (e.g., end-point device 130). The edge nodes 202 may execute test cases on applications running on the end-point devices, allowing for real-time monitoring and analysis of application behavior without imposing significant computational overhead on the end-point devices.

Each edge node 202 may be configured to receive test execution instructions from the system and interact with the applications on the end-point devices to execute the corresponding test cases. The edge nodes 202 may operate autonomously or in coordination with other edge nodes to perform distributed test execution across multiple applications and devices. Each edge node 202 may include a self-monitoring agent 202A, which may be configured to observe, collect, and transmit execution data in real time during the execution of test cases on applications running on the end-point devices. The self-monitoring agent 202A may operate as an autonomous monitoring component within the edge node 202, enabling continuous tracking of application behavior, system performance, and test execution outcomes. By embedding self-monitoring capabilities within each edge node 202, the system may ensure that execution variability, performance anomalies, and security-related failures are detected and logged during test execution.

The self-monitoring agent 202A may collect execution data, which may include application performance monitoring (APM) metrics 204, security and permission logs 206, and data transformation logs 208. The APM metrics may provide insights into system resource utilization, including CPU load, memory consumption, and response times, allowing for the identification of performance-related execution variability. The security and permission logs may capture authentication events, access control verifications, and encryption operations, enabling the detection of failures related to security restrictions or policy enforcement. The data transformation logs may track how data is modified during test execution, capturing issues such as precision loss, serialization errors, or schema mismatches that may contribute to inconsistent test outcomes.

Referring again to FIG. 2, the self-monitoring agent 202A may transmit the collected execution data for swarm analysis 210. Swarm analysis generally refers to a computational approach that leverages decentralized, collective intelligence to analyze patterns, detect anomalies, and optimize decision-making processes. Inspired by swarm behavior in nature, such as the movement of flocks of birds or colonies of ants, swarm-based computing techniques use distributed processing to dynamically assess changing conditions and adapt to evolving data sets. Swarm analysis may be particularly useful in complex systems where variability arises from multiple interdependent components, as it enables adaptive detection of inconsistencies without relying on predefined static thresholds.

In specific embodiments, swarm analysis 210 may be performed by a swarm analyzer module within the data processing subsystem. The swarm analyzer module may process execution data collected from multiple edge nodes 202 to detect execution variability in test cases. The swarm analyzer module may identify inconsistencies across distributed test executions by aggregating execution data, including application performance monitoring (APM) metrics, security validation logs, and data transformation logs. By applying swarm-based intelligence, swarm analysis 210 may compare execution patterns across different test runs, dynamically recognizing deviations that may indicate test instability or environmental variability.

Swarm analysis 210 may be used to classify execution variability based on observed fluctuations in test performance, system resource utilization, and security enforcement outcomes. In some instances, swarm analysis 210 may detect transient anomalies that do not persist across multiple executions, distinguishing them from systemic test failures that require further analysis. By leveraging swarm intelligence principles, the system may dynamically assess test case behavior in real time, enabling early detection of execution instability without requiring manual intervention.

The data processing subsystem may transmit execution variability indicators and associated execution data from swarm analysis 210 to test case analysis 212 for further evaluation. By first pre-processing execution data through swarm analysis 210, the system 140 may efficiently filter transient anomalies and focus computational resources on identifying persistent execution inconsistencies. Test case analysis may generally refer to the process of evaluating test execution data to determine patterns, detect inconsistencies, and classify execution variability. In example embodiments, test case analysis may involve identifying dependencies between test cases, assessing data transformation integrity, and verifying security and access control enforcement. Test case analysis may provide deeper insights into the root causes of execution variability by correlating multiple sources of execution data and applying structured evaluation techniques.

In specific embodiments, test case analysis 212 may be performed by a test case analyzer module within the data processing subsystem. The test case analyzer module may receive execution variability indicators from swarm analyzer module and further process the execution data to conduct dependency impact analysis, data transformation integrity analysis, and security and access validation analysis. These analyses may be performed to determine whether execution variability is due to changes in system dependencies, inconsistencies in data handling, or security constraints affecting test execution.

The test case analyzer module may generate execution analysis data that describes the specific nature of execution variability detected in test cases. This execution analysis data may undergo dependency analysis 214, data transformation analysis 216, and security and permission analysis 218 to determine a dependency impact portfolio, data transformation integrity metrics, and a security and access validation dataset, respectfully. The dependency impact portfolio may capture relationships between upstream and downstream test cases, execution flow sequences, and cascading failure effects. The data transformation integrity metrics may include format consistency parameters, serialization patterns, and precision tracking to detect inconsistencies in how data is processed during test execution. The security and access validation dataset may include authentication logs, access policy compliance data, and encryption validation results to assess whether security enforcement affects test execution outcomes.

The execution analysis data generated by the test case analyzer module may be transmitted to a machine learning subsystem for further evaluation. By performing structured test case analysis 212 after swarm analysis 210, the system may refine its assessment of execution variability, maintaining that only meaningful inconsistencies are processed for root cause determination. In doing so, the system may improve diagnostic accuracy and reduce false positives in execution variability classification.

The machine learning subsystem may process the execution analysis data to determine the root cause of execution variability in test cases and generate responsive actions for modifying test execution. Machine learning-based test analysis may involve statistical modeling, pattern recognition, and predictive analytics to identify causes of test failures and execution variability. Conventional rule-based systems may be limited in detecting complex relationships within execution data, whereas machine learning techniques may dynamically adapt to execution patterns and provide probabilistic assessments of test case stability.

In specific embodiments, the machine learning subsystem may implement a neuro-symbolic model to process execution analysis data, i.e., neuro-symbolic analysis 220. A neuro-symbolic model is an artificial intelligence framework that combines neural network-based learning with symbolic reasoning techniques to improve both the accuracy and interpretability of data-driven decision-making. Traditional machine learning models, particularly deep learning-based approaches, are capable of recognizing complex patterns within large datasets but often function as black-box systems, providing limited insight into their decision-making processes. Conversely, symbolic reasoning models operate using explicitly defined rules, logical inferences, and structured representations, making them interpretable but often less adaptable to evolving data. By integrating these two approaches, a neuro-symbolic model provides a hybrid solution that enhances both learning-based adaptability and rule-based explainability, making it particularly suited for complex, data-driven environments such as test execution diagnostics.

In specific embodiments, the neuro-symbolic model may be composed of at least two primary components: (i) a neural network component 220A, and (ii) a symbolic reasoning component 220C. The neural network component may be trained to process execution analysis data, which may include dependency impact portfolios, data transformation integrity metrics, and security and access validation datasets. The neural network may employ supervised or unsupervised learning techniques to detect patterns within execution data, classify execution variability, and predict the likelihood of a given test case exhibiting inconsistent behavior. The output of the neural network may include probability scores 220B, which quantify the likelihood that an execution variability event is occurring based on prior learned patterns. The probability scores 220B may be calculated using one or more activation functions, such as softmax or sigmoid functions, to assign likelihood values within a defined range.

The symbolic reasoning component may receive probability scores 220B from the neural network and apply a set of predefined rules and logical inferences to classify execution variability events. The symbolic reasoning engine may contain a rule-based inference system, which may map execution variability patterns to structured decision trees, ontologies, or knowledge graphs that define causal relationships between execution events. The reasoning engine may use if-then logic statements, formal knowledge representations, or expert-defined constraints to interpret execution variability and generate a classification dataset that associates probability scores with explanatory reasoning.

In example embodiments, the classification dataset may include execution variability labels, categorizing test failures into structured classes (e.g., dependency-related failures, security access violations, or data transformation anomalies), failure severity scores, which may be assigned based on a combination of probability scores and rule-based thresholds, and explanatory reasoning, which may provide a human-readable output describing why an execution variability event has been classified in a certain way.

The neuro-symbolic model may operate iteratively, refining its classification accuracy over time through a feedback loop. The symbolic reasoning engine may feed results back to the neural network, allowing the model to adapt its probability score assignments based on corrected classifications. Such a continuous learning process may improve the model's ability to generalize execution variability patterns across different test cases and computing environments. By integrating neural networks with symbolic reasoning, the neuro-symbolic model may provide high interpretability while maintaining the flexibility of deep learning-based predictions. This approach may enable the machine learning subsystem to not only detect execution variability with high accuracy but also explain why certain test cases exhibit inconsistencies.

In specific embodiments, the execution variability classification dataset generated by the neuro-symbolic model may undergo root cause analysis 222 to determine the underlying reason for execution variability by correlating execution analysis data with system-wide conditions, including test dependencies, security enforcement policies, and data transformation operations. In particular, the root cause analysis 222 may include identifying whether execution variability is due to software defects, infrastructure limitations, test environment fluctuations, or external constraints such as network latency; mapping execution variability to historical test case patterns, allowing the system to determine whether a test case has exhibited similar failures in past executions; assessing execution variability severity by comparing observed behavior with expected system performance metrics, stored in a reference model based on prior validated test executions; and classifying root causes based on their impact on downstream test cases, ensuring that dependency-related failures are properly categorized.

In some implementations, root cause analysis 222 may utilize causal inference models to determine the probabilistic relationship between execution variability and its underlying causes. The root cause analysis 222 may output responsive action 224 recommendations, which may include modifications to test execution parameters, security configurations, data transformation processes, or dependency management strategies. These responsive actions 224 may be transmitted to action implementation 226 for stakeholder review and execution.

Action implementation 226 may be configured to process the corrective action recommendations received from root cause analysis 222 and determine whether they should be implemented. The action implementation 226 may include a structured decision-making process that incorporates stakeholder feedback, automated validation mechanisms, and decentralized governance models. In some implementations, the system may utilize a DAO model within action implementation 226 to facilitate stakeholder decision-making on whether a proposed corrective action should be applied. Stakeholders, which may include developers, testers, security analysts, and quality assurance engineers, may review execution variability findings and confirm whether the identified root cause requires modification to the test execution process. Action implementation 226 may store stakeholder-approved corrective actions in a smart contract 228, such that test execution modifications are transparent, immutable, and enforceable. The smart contract 228 may contain execution parameters that define how the test case should be re-executed, specifying adjustments to test case dependencies, security settings, data transformation policies, or test scheduling mechanisms.

The stakeholder-approved corrective actions stored in the smart contract 228 may be executed by deploying updated test execution parameters to the edge nodes 202, such that future test runs incorporate the approved modifications. The deployment process may involve updating configuration files, modifying test scripts, or adjusting execution schedules to align with the approved corrective actions. Then, the test case adjustments may be enforced in a verifiable manner, wherein the smart contract 228 ensures that only authorized modifications are applied to the test execution process. This may involve cryptographic verification techniques, immutable logging of changes in a distributed ledger, or access control enforcement to prevent unauthorized modifications to execution parameters. By utilizing a decentralized and tamper-resistant execution model, the system may guarantee that test modifications are applied consistently across all edge nodes 202. Then, the automated regression tests may be triggered in response to the dependency-related modifications, wherein the system initiates targeted regression testing when modifications to test dependencies are detected. This may include executing a subset of test cases that are directly impacted by the modified dependencies, validating whether the applied changes resolve execution variability without introducing unintended failures. The system may assess regression test outcomes by comparing post-modification execution data against prior stable test results, such that the implemented corrective actions improve test stability without adversely affecting system performance.

In some embodiments, the system may be configured to execute test cases incorporating the modifications stored in the smart contract 228 by deploying modified test cases to edge nodes 202, such that test execution reflects stakeholder-approved corrections; executing test cases in real-time, applying updated security policies, data transformation rules, or dependency adjustments; and collecting new execution data to determine whether execution variability has been successfully mitigated. The system may continuously monitor execution results, comparing new test case outcomes with prior execution variability patterns. If execution variability is no longer observed, the test case may be marked as stable, and no further intervention may be required. If execution variability persists, the system may reinitiate the analysis cycle, refining corrective action strategies until test execution stability is achieved. By implementing an automated re-execution process, the system may maintain that test case modifications are applied consistently across distributed computing environments, enabling continuous validation of execution variability mitigation strategies without requiring manual intervention.

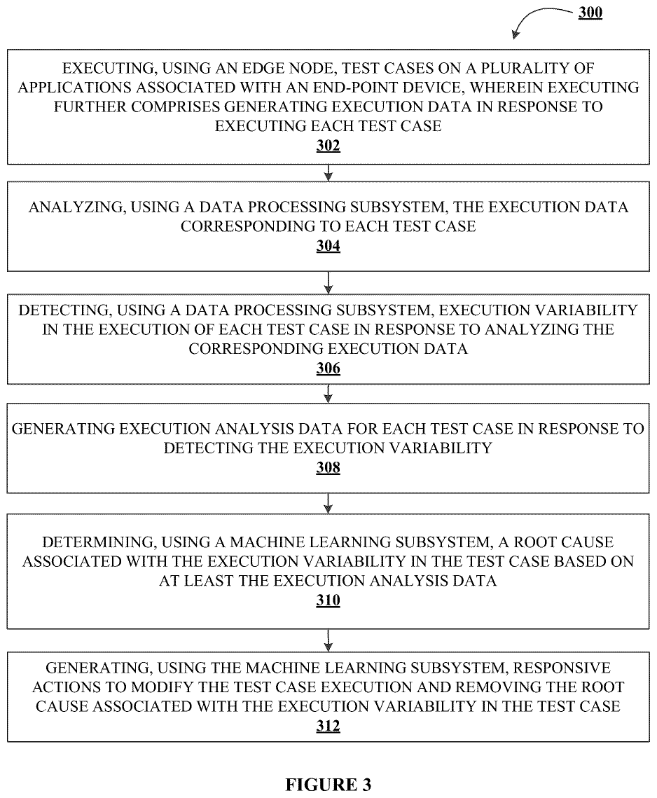

FIG. 3 illustrates a process flow for automated test analysis and diagnostics in a distributed computing environment, in accordance with an embodiment of the disclosure. As shown in block 302, the process flow includes executing test cases on a plurality of applications associated with an end-point device using an edge node. The edge node may be instantiated as an independent computing resource within the distributed computing environment or deployed directly on the end-point device. The edge node may communicate with the system over a network and receive instructions specifying which test cases to execute.

During execution, the edge node may interact with the application under test, simulating user interactions, system inputs, or external service calls to evaluate the application's functionality, performance, and security compliance. The execution process may be governed by predefined test parameters, including test case conditions, expected output validations, and system resource constraints. In response to executing each test case, the edge node may generate execution data, which may comprise performance metrics, security validation logs, and data transformation records. The execution data may be collected in real time using a self-monitoring agent embedded within the edge node. The self-monitoring agent may track system resource utilization, authentication attempts, access control enforcement, and data processing activities occurring during test execution. This execution data may serve as the basis for subsequent analysis and detection of execution variability.

In some implementations, multiple edge nodes may execute test cases in parallel across different applications and environments, allowing for scalable and distributed test execution. The edge nodes may operate autonomously or in coordination with other edge nodes to replicate real-world deployment scenarios.

As shown in block 304, the process flow includes analyzing the execution data corresponding to each test case using a data processing subsystem. Once the edge node has executed a test case and generated execution data, this data may be transmitted to the data processing subsystem for further evaluation. The data processing subsystem may be a centralized or distributed computing resource that processes execution data to assess test stability, performance, and security compliance. The analysis process may involve parsing, filtering, and structuring the execution data received from multiple edge nodes. The data processing subsystem may normalize execution data from different environments to create a consistent dataset that facilitates pattern recognition and anomaly detection. The analysis may include evaluating APM metrics-including CPU utilization, memory consumption, response times, and input/output throughput, security and access validation logs-detailing authentication attempts, permission enforcement, encryption states, and policy compliance, and data transformation records capturing serialization, deserialization, precision loss, and schema mapping errors.

The data processing subsystem may store analyzed execution data in a structured format, enabling historical comparison and trend analysis. The system may maintain execution history logs to track changes in test performance over time, identifying deviations from expected behavior. In some implementations, metadata describing test environment conditions, execution timestamps, and system state snapshots may be appended to the execution data to improve the accuracy of subsequent variability detection. The data processing subsystem may also implement preliminary anomaly detection algorithms to flag execution data exhibiting deviations from expected thresholds. These preliminary findings may assist in prioritizing test cases for deeper analysis. Once execution data has been analyzed, it may be transmitted to the next stage of processing, where execution variability is detected.

As shown in block 306, the process flow includes detecting execution variability in the execution of each test case using the data processing subsystem in response to analyzing the corresponding execution data. Execution variability may refer to inconsistencies in test outcomes across multiple executions, including fluctuations in performance, unexpected failures, security policy enforcement inconsistencies, or data transformation anomalies.

As described herein, the swarm analyzer module within the data processing subsystem may perform swarm analysis to detect execution variability by comparing execution data across multiple test runs, identifying patterns of instability, and distinguishing between transient anomalies and persistent inconsistencies. Swarm analysis may involve aggregating execution data from multiple edge nodes, applying collective intelligence models to assess variability trends, and generating execution variability indicator. As such, the execution variability detection may involve, (i) performance variability-where fluctuations in CPU usage, response times, or memory consumption exceed predefined stability thresholds, (ii) security policy inconsistencies-where test cases fail due to unexpected authentication errors, permission denials, or encryption enforcement anomalies, and (iii) data transformation inconsistencies-where serialization, precision loss, or schema mismatches result in test failures or incorrect data propagation.

In specific embodiments, the swarm analyzer module may generate execution variability indicators, which may be used to classify test cases based on the degree and frequency of variability observed. These indicators may include variability confidence scores indicating the likelihood that a test case exhibits execution instability based on statistical analysis of prior test results, failure clustering data that groups similar test cases that exhibit execution variability due to shared dependencies or common environmental conditions, and regression sensitivity metrics to identify whether recent system updates or configuration changes have impacted test stability.

As shown in block 308, the process flow includes generating execution analysis data for each test case in response to detecting execution variability using a test case analyzer module within the data processing subsystem. Once execution variability has been identified, the test case analyzer module may further process the execution variability indicators and associated execution data to classify the nature of the variability and determine contributing factors. Execution analysis data may include a dependency impact portfolio, a data transformation integrity metrics, and security and access validation dataset. A dependency impact portfolio may include, (i) interdependency mappings, which define relationships between test cases and identify whether execution variability in one test case is influenced by the success or failure of another test case. The interdependency mappings may be established by analyzing test execution order, shared data sources, and function call dependencies, (ii) execution flow tracking, which monitors the sequence and timing of test execution to assess whether changes in system conditions or delays in upstream processing impact the stability of dependent test cases. Execution flow tracking may enable the identification of conditions, resource contention issues, and synchronization errors that contribute to execution variability, (iii) historical execution patterns, which store prior test execution data to detect recurring dependency-related inconsistencies. By comparing current execution data with historical records, the system may determine whether an observed variability is an isolated event or part of a larger trend, and/or (iv) regression test triggers, which determine whether an upstream failure necessitates the re-execution of dependent test cases. If a test case that has passed in prior executions begins to fail due to modifications in related system components, regression test triggers may prompt automated retesting to ensure continued stability. By generating a dependency impact portfolio, the test case analyzer module may determine whether execution variability is influenced by external system dependencies, providing a structured dataset that allows for deeper root cause analysis.

As shown in block 308, the process flow includes generating execution analysis data for each test case in response to detecting execution variability using a test case analyzer module within the data processing subsystem. Once execution variability has been identified, the test case analyzer module may further process the execution variability indicators and associated execution data to classify the nature of the variability and determine contributing factors. Execution analysis data may include a dependency impact portfolio, data transformation integrity metrics, and a security and access validation dataset.

As described herein, the dependency impact portfolio may include interdependency mappings, execution flow tracking, impact propagation metrics, historic execution patterns, regression test triggers, and/or the like. Interdependency mappings, which define relationships between test cases and identify whether execution variability in one test case may be influenced by the success or failure of another test case. The interdependency mappings may be established by analyzing test execution order, shared data sources, and function call dependencies. Execution flow tracking, which monitors the sequence and timing of test execution to assess whether changes in system conditions or delays in upstream processing impact the stability of dependent test cases. Execution flow tracking may enable the identification of conditions, resource contention issues, and synchronization errors that contribute to execution variability. Impact propagation metrics, which quantify how failures in one test case affect the execution of downstream tests. These metrics may be derived from historical execution patterns and statistical models that assess how failure propagation influences test reliability. Historical execution patterns, which store prior test execution data to detect recurring dependency-related inconsistencies. By comparing current execution data with historical records, the system may determine whether an observed variability is an isolated event or part of a larger trend. Regression test triggers, which determine whether an upstream failure necessitates the re-execution of dependent test cases. If a test case that has passed in prior executions begins to fail due to modifications in related system components, regression test triggers may prompt automated retesting to ensure continued stability. By generating a dependency impact portfolio, the test case analyzer module may determine whether execution variability is influenced by external system dependencies, providing a structured dataset that enables deeper root cause analysis.

As described herein, the data transformation integrity metrics may include data format consistency verification, precision and rounding variation detection, serialization and deserialization validation, cross-system data validation, schema and type compliance verification, and/or the like. Data format consistency verification, which ensures that data maintains a uniform format across different stages of processing. This may include verifying that data structures, encoding schemes, and field arrangements remain consistent between source and destination systems. Variability in format consistency may result in data parsing errors, truncation issues, or incorrect system behavior during test execution. Precision and rounding variation detection, which evaluates whether floating-point precision loss, rounding inconsistencies, or numerical representation errors affect computational test outcomes. Some test cases may rely on precise numerical operations, and inconsistencies introduced by different computing architectures, conversion processes, or storage representations may lead to discrepancies in expected results. Serialization and deserialization validation, which analyzes whether data structures remain intact when being converted between different formats, such as binary, JSON, XML, or protocol buffers. Serialization inconsistencies may introduce errors when reconstructing data, resulting in test failures. The system may detect missing fields, altered character encodings, or truncated records caused by serialization or deserialization failures. Cross-system data validation, which ensures that data exchanged between interdependent systems remains unchanged, complete, and correctly interpreted. Some test cases may involve multiple systems that process and modify data at different stages, and inconsistencies in data transformation across these systems may introduce unexpected execution variability. Schema and type compliance verification, which ensures that data transformations adhere to predefined schema definitions and expected data types. This verification may detect cases where data fails to conform to predefined structure rules, type constraints, or expected formats, which may result in runtime failures, parsing errors, or test execution inconsistencies. By generating data transformation integrity metrics, the test case analyzer module may determine whether execution variability is caused by improper data handling, conversion errors, or inconsistencies in how data is interpreted across different components.

As described herein, the security and access validation dataset may include authentication and authorization logs, access control policy and compliance records, encryption and data integrity validation, failed authentication and permission denial events, security exception and anomaly detection, and/or the like. Authentication and authorization logs, which track user identity verification, authentication tokens, and session management events. These logs may be used to detect failures related to invalid credentials, expired authentication tokens, or misconfigured identity access management (IAM) policies that prevent successful test execution. Access control policy compliance records, which verify whether test cases comply with predefined security policies governing role-based access control (RBAC), attribute-based access control (ABAC), and discretionary access control (DAC). If a test case fails due to inadequate permissions, the system may determine whether the failure is expected based on security policies or an anomaly that requires further investigation. Encryption and data integrity validation, which ensures that encrypted data is properly handled during test execution and remains accessible under expected security conditions. The system may verify that encryption keys, hashing functions, and cryptographic protocols do not introduce unexpected execution variability. Failed authentication and permission denial events, which capture instances where test cases fail due to access restrictions. These events may be analyzed to determine whether failures result from incorrectly configured security policies, temporary credential revocation, or missing user roles that prevent access to required system resources. Security exception and anomaly detection, which monitors deviations from expected security behavior. The system may analyze intrusion detection system (IDS) logs, security event monitoring (SEM) alerts, and access patterns to detect potential security threats, unauthorized access attempts, or misconfigured firewall rules that affect test execution stability. By generating a security and access validation dataset, the test case analyzer module may determine whether execution variability is caused by security policy enforcement, authentication failures, or access control inconsistencies.

As shown in block 310, the process flow includes determining a root cause associated with the execution variability in the test case using a machine learning subsystem. As described herein, the machine learning subsystem may process execution analysis data, including the dependency impact portfolio, data transformation integrity metrics, and security and access validation dataset, to identify the underlying factors contributing to execution variability. Root cause determination may involve a multi-stage analysis process, wherein the machine learning subsystem first quantifies execution variability, then classifies it into structured categories, and finally determines the most probable cause of test instability. The machine learning subsystem may achieve this using a neuro-symbolic model, which integrates neural network-based learning with symbolic reasoning techniques to enhance interpretability and accuracy.

In specific embodiments, the machine learning subsystem may apply neural network-based processing to analyze execution variability patterns and assign probability scores to test cases based on their likelihood of instability. This may involve feature extraction, wherein execution analysis data is converted into numerical representations suitable for machine learning-based pattern recognition; pattern recognition, wherein prior test execution data is analyzed to identify statistical correlations between execution variability and known failure causes; and/or probability score generation, wherein a likelihood score is assigned to each test case, quantifying the probability that execution variability is due to dependency issues, data transformation inconsistencies, or security constraints.

Once probability scores have been generated, the machine learning subsystem may apply symbolic reasoning to map test cases to predefined execution variability categories. This process may involve rule-based inference, wherein execution variability is compared against structured decision trees, ontologies, or expert-defined constraints; causal relationship mapping, wherein execution variability is linked to dependency failures, data transformation inconsistencies, or access control violations based on previously established patterns; and execution variability classification dataset generation, wherein test cases are categorized into structured labels, including dependency-related execution variability (caused by upstream/downstream failures), data transformation-related execution variability (caused by serialization, schema mismatches, or precision errors), and/or security-related execution variability (caused by authentication failures, encryption misconfigurations, or policy enforcement restrictions).

After execution variability has been classified, the machine learning subsystem may determine the root cause of test failures by analyzing causal relationships between execution variability and known system behaviors. This may involve identifying whether execution variability is caused by software defects, infrastructure constraints, test environment fluctuations, or external constraints such as network latency, comparing current execution behavior against historical patterns to determine whether variability represents a new issue or a recurring failure mode, and assessing severity levels, wherein the system evaluates how execution variability affects overall test stability and prioritizes the most critical issues.

As shown in block 312, the process flow includes generating responsive actions using the machine learning subsystem to modify test case execution and mitigate the root cause of execution variability. Once the machine learning subsystem has determined the root cause, it may generate a set of corrective measures designed to address the specific factors contributing to execution instability. The responsive actions may be structured as modifications to test execution parameters, addressing issues identified in dependency management, data transformation, and security enforcement.

The machine learning subsystem may generate dependency adjustment actions to modify test execution workflows and resolve issues identified in the dependency impact portfolio. These actions may include reordering test case execution to ensure that upstream dependencies have completed successfully before executing dependent test cases, isolating test cases that exhibit execution variability due to external system dependencies to enable independent validation, and triggering automated regression tests when a dependency modification impacts downstream components. By modifying dependency relationships within the test execution environment, the system may ensure that test failures do not propagate unpredictably due to interdependent system conditions.

The machine learning subsystem may further generate data transformation correction actions to adjust test configurations and improve consistency in data handling, serialization, and precision management. These actions may include enforcing schema validation before test execution to ensure that input data conforms to expected formats, applying precision controls to mitigate variability caused by floating-point inconsistencies or rounding errors, and enabling cross-system data normalization to prevent discrepancies between interconnected test environments. These modifications may allow test cases to execute more reliably when processing transformed data across multiple environments or applications.

In addition to dependency and data transformation adjustments, the machine learning subsystem may generate security and access control adjustments to refine security configurations and resolve access validation failures or policy enforcement inconsistencies. These actions may include modifying access control policies to grant appropriate permissions without compromising security integrity, adjusting authentication parameters to ensure test cases have valid security credentials when accessing protected resources, and reconfiguring encryption settings to ensure data remains accessible without violating encryption policies. By implementing security adjustments based on detected execution variability, the system may prevent unnecessary test failures caused by restrictive security policies or authentication mismatches.

The machine learning subsystem may format the generated responsive actions into a structured execution policy, which may be transmitted to the action implementation subsystem for validation and execution. The execution policy may include a description of the identified execution variability and corresponding root cause, the specific test execution parameters to be modified, and the conditions under which the modifications should be applied. Additionally, the execution policy may define expected outcomes for the modified test execution process to ensure that corrective actions result in improved test stability. Once the responsive actions have been generated, they may be evaluated, approved, and enforced by the action implementation subsystem before initiating the re-execution of the affected test cases.

The action implementation subsystem may receive the structured execution policy generated by the machine learning subsystem and encode the approved modifications as enforceable execution parameters within a smart contract. The smart contract may define specific modifications to test execution parameters, including adjustments to dependency relationships, data transformation rules, and security configurations. The smart contract may further specify the conditions under which test re-execution should occur, such that modifications are applied only when necessary. By recording the smart contract in a distributed ledger, the system may establish a tamper-resistant, transparent, and auditable record of the approved modifications, preventing unauthorized changes to test execution parameters.

Once the smart contract has been recorded, the action implementation subsystem may transmit the test case re-execution parameters to the edge node. Upon receiving the re-execution parameters, the edge node may update its execution environment, applying the approved modifications before initiating re-execution. The action implementation subsystem may then validate that the edge node has successfully implemented the modifications by comparing the updated execution environment with the parameters specified in the smart contract. This validation process may include confirming that updated test scripts, modified dependency structures, or adjusted security configurations have been correctly applied before proceeding with re-execution.

Once the system determines that the edge node has implemented the re-execution parameters, the action implementation subsystem may automatically re-execute the test case under the modified execution conditions. The re-execution process may follow the same procedural steps as the initial execution, with the updated parameters applied to ensure that previously identified execution variability has been addressed. The system may then collect new execution data from the re-executed test case, which may be analyzed to determine whether the applied modifications have successfully mitigated execution variability.

By implementing smart contract-based execution governance, the system may ensure that responsive actions are applied consistently across distributed test environments while maintaining auditability, transparency, and security. The structured approach to test re-execution ensures that corrective actions are validated before being enforced, preventing unnecessary modifications and ensuring that test cases execute under optimal conditions.

Once the edge node has re-executed the test case under the modified execution parameters, the system may collect and analyze new execution data to determine whether the applied modifications successfully mitigated execution variability. The new execution data may be transmitted from the edge node to the data processing subsystem, where it may undergo the same analysis pipeline used in initial test execution. The system may compare the post-modification execution data with prior execution variability indicators to assess whether performance inconsistencies, security failures, or data transformation issues have been resolved. If the variability metrics indicate that the test case now exhibits stable execution behavior, the test case may be marked as validated, and no further modifications may be required. If execution variability persists, the system may initiate an iterative feedback loop, wherein the newly collected execution data is transmitted back to the machine learning subsystem for further analysis. The machine learning subsystem may refine its execution variability classification dataset, update neural network weightings, and adjust symbolic reasoning parameters to improve its root cause determination capabilities. The refined insights may then be used to generate a new set of responsive actions, which may again be transmitted to the action implementation subsystem for enforcement.

For transparency and maintaining an audit trail, the validation results may be recorded in the distributed ledger, associating each test case modification with its corresponding execution outcome. In some implementations, the system may allow stakeholders to provide manual feedback through a DAO-based governance model, wherein testers, developers, or quality assurance engineers may determine whether additional corrective actions should be applied or if the test case should be marked as stable. By integrating an automated validation and feedback loop, the system may continuously refine its execution variability detection, root cause determination, and corrective action implementation processes. This iterative approach maintains that test execution stability is consistently improved while minimizing false positives in variability detection. The system may dynamically adjust test execution strategies, machine learning models, and dependency management policies to adapt to evolving test environments, ensuring optimal performance across distributed computing applications.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the methods described above may include fewer steps in some cases, while in other cases the methods may include additional steps. The steps of the methods and modifications to the steps of the methods described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for automated test analysis and diagnostics in a distributed computing environment, the system comprising:
an edge node, wherein the edge node is configured to execute test cases on a plurality of applications associated with an end-point device, wherein edge node is further configured to generate execution data in response to executing each test case;
a data processing subsystem operatively coupled to the edge node, wherein the data processing subsystem is configured to:
analyze the execution data corresponding to each test case;
detect execution variability in the execution of each test case in response to analyzing the corresponding execution data; and
generate execution analysis data for each test case in response to detecting the execution variability; and
a machine learning subsystem operatively coupled to the data processing subsystem, wherein the machine learning subsystem is configured to:
determine a root cause associated with the execution variability in the test case based on at least the execution analysis data; and
generate responsive actions to modify the test case execution and removing the root cause associated with the execution variability in the test case.

2. The system of claim 1, wherein the edge node is one or a plurality of edge nodes.

3. The system of claim 1, wherein the edge node further comprises a smart self-monitoring agent, wherein the smart self-monitoring agent is configured to:
monitor, in real-time, the execution of test cases on the plurality of applications; and
generate the execution data based on at least monitoring the execution of test cases, wherein the execution data comprises at least one of Application Performance Monitoring (APM) metrics, security and permission logs, or data transformation logs.

4. The system of claim 1, wherein the data processing subsystem is further configured to:
detect, using a swarm analyzer module, the execution variability in the execution of each test case.

5. The system of claim 1, wherein the data processing subsystem is further configured to:
generate, using a test case analyzer module, the execution analysis data, wherein the execution analysis data comprises at least one of dependency impact portfolio, data transformation integrity metrics, and security and access validation dataset.

6. The system of claim 5, wherein the dependency impact portfolio comprises at least one of interdependency mappings between the test cases, identifying relationships between upstream and downstream test case executions, execution flow data capturing a sequence and timing of dependent test cases to assess cascading failure effects, impact propagation metrics determining a degree to which failures in one test case influence execution of related test cases, historical execution patterns analyzing prior test results to detect recurring dependency-related inconsistencies, or regression test triggers identifying conditions under which a failure in an upstream test necessitates a re-execution of related downstream test cases.

7. The system of claim 5, wherein the data transformation integrity metrics comprises at least one of data format consistency parameters, precision and rounding variation metrics, serialization and deserialization consistency data, cross-system data validation records, or schema and type compliance indicators.

8. The system of claim 5, wherein the security and access validation dataset comprises at least one of authentication and authorization logs, access control policy compliance records, encryption and data integrity validation parameters, failed authentication and permission denial events, or security exception and anomaly detection indicators.

9. The system of claim 1, wherein the machine learning subsystem is further configured to:
implement a neuro-symbolic model on the execution analysis data, wherein implementing the neuro-symbolic model further comprises:
generating, using a neural network, probability scores indicating a likelihood of execution variability; and
interpreting, using a rule-based inference engine, the probability scores by correlating execution variability patterns with predefined domain-specific rules to generate an execution variability classification dataset.

10. The system of claim 9, wherein the machine learning subsystem is further configured to:
determine the root cause associated with the execution variability based on at least the execution variability classification dataset.

11. The system of claim 1, further comprising an action implementation subsystem, wherein the action implementation subsystem is configured to:
store the responsive actions in a smart contract as test case re-execution parameters; and
recording the smart contract in a distributed ledger.

12. The system of claim 11, wherein the action implementation subsystem is further configured to:
transmit the test case re-execution parameters to the edge node;
determine that the edge node has implemented the re-execution parameters; and
automatically re-execute the test case in response to determining that the edge node has implemented the re-execution parameters.

13. A method for automated test analysis and diagnostics in a distributed computing environment, the method comprising:
executing, using an edge node, test cases on a plurality of applications associated with an end-point device, wherein executing further comprises generating execution data in response to executing each test case;
analyzing, using a data processing subsystem, the execution data corresponding to each test case;
detecting, using a data processing subsystem, execution variability in the execution of each test case in response to analyzing the corresponding execution data;
generating execution analysis data for each test case in response to detecting the execution variability;
determining, using a machine learning subsystem, a root cause associated with the execution variability in the test case based on at least the execution analysis data; and
generating, using the machine learning subsystem, responsive actions to modify the test case execution and removing the root cause associated with the execution variability in the test case.

14. The method of claim 13, wherein the edge node is one or a plurality of edge nodes.

15. The method of claim 13, wherein generating the execution data further comprises:
monitoring, in real-time, using a smart self-monitoring agent, the execution of test cases on the plurality of applications; and
generating, using the smart self-monitoring agent, the execution data based on at least monitoring the execution of test cases, wherein the execution data comprises at least one of Application Performance Monitoring (APM) metrics, security and permission logs, or data transformation logs.

16. The method of claim 13, wherein detecting the execution variability in the execution of each test case further comprises using a swarm analyzer module.

17. The method of claim 13, wherein generating the execution analysis data further comprises using a test case analyzer module, wherein the execution analysis data comprises at least one of dependency impact portfolio, data transformation integrity metrics, and security and access validation dataset.

18. The method of claim 17, wherein the dependency impact portfolio comprises at least one of interdependency mappings between the test cases, identifying relationships between upstream and downstream test case executions, execution flow data capturing a sequence and timing of dependent test cases to assess cascading failure effects, impact propagation metrics determining a degree to which failures in one test case influence execution of related test cases, historical execution patterns analyzing prior test results to detect recurring dependency-related inconsistencies, or regression test triggers identifying conditions under which a failure in an upstream test necessitates a re-execution of related downstream test cases.

19. The method of claim 17, wherein the data transformation integrity metrics comprises at least one of data format consistency parameters, precision and rounding variation metrics, serialization and deserialization consistency data, cross-system data validation records, or schema and type compliance indicators.

20. A computer program product for automated test analysis and diagnostics in a distributed computing environment, the computer program product comprising a non-transitory computer-readable medium comprising code configured to cause an apparatus to:
execute, using an edge node, test cases on a plurality of applications associated with an end-point device, wherein executing further comprises generating execution data in response to executing each test case;
analyze, using a data processing subsystem, the execution data corresponding to each test case;
detect, using a data processing subsystem, execution variability in the execution of each test case in response to analyzing the corresponding execution data;
generate execution analysis data for each test case in response to detecting the execution variability;
determine, using a machine learning subsystem, a root cause associated with the execution variability in the test case based on at least the execution analysis data; and
generate, using the machine learning subsystem, responsive actions to modify the test case execution and removing the root cause associated with the execution variability in the test case.
